(19) United States
(12) Patent Application Publication
(10) Pub. No.: US 2007/0188335 A1
(43) Pub. Date: Aug. 16, 2007

(54) Electrical distribution apparatus including a sensor structured to detect smoke or gas emitted from overheated plastic

(75) Inventor: John J. Shea, Pittsburgh, PA (US)

Correspondence Address: MARTIN J. MORAN, ESQ.;Eaton Electrical, Inc., Technology & Quality Center, 170 Industry Drive, RIDC Park West, Pittsburg, PA, 15275-1032, US

(73) Assignee: EATON CORPORATION

(21) Appl. No.: 11/352,148

(22) Filed: Feb. 10, 2006

(51) Int. Cl. G08B 17/10

(52) U.S. Cl. 340/628; 340/632

(57) ABSTRACT

An electrical distribution apparatus, such as a load center, includes an enclosure, a plurality of circuit breakers within the enclosure, and a smoke or gas sensor structured to detect smoke or gas emitted from overheated plastic within the enclosure. A detection circuit cooperates with the smoke or gas sensor and is structured to trip one of the circuit breakers in response to the detected smoke or gas emitted from overheated plastic or to annunciate the detected smoke or gas emitted from overheated plastic.

### BACKGROUND OF THE INVENTION

1. Field of the Invention

This invention pertains generally to electrical apparatus and, more particularly, to electrical distribution apparatus, such as for example, load centers, panelboards, motor control centers and switchgear.

2. Background Information

Electrical equipment (e.g., without limitation, circuit interrupters, such as for example, circuit breakers; power busses; electric meters; transformers; relays) are typically housed within an electrical distribution apparatus, such as for example, a load center, panelboard, motor control center or switchgear.

For example, in a load center, various components and electrical connections, especially bus stab connections and downstream circuit breaker conductors, are susceptible to overheating that can potentially cause a fire. In the case of the bus stab connections, the overheating can occur from fretting corrosion, defective plating, damaged mating surfaces, oxidation, or defective or damaged spring clips. These conditions can lead to excessive joint resistance that can become increasingly resistive over time—eventually causing an overheated electrical joint that can arc and potentially lead to a fire.

U.S. Pat. No. 6,839,212 discloses a thermal detection system including a plural pole circuit breaker, lead bus bars and a resistance temperature detector adhesive tape connected to the bus bars and to an electronic circuit that detects the resistance change in the tape. In turn, the tape sends a signal to a shunt trip connected to the circuit breaker.

U.S. Patent Application Publication No. 2004/0218330 discloses a gas detection module and a main circuit breaker of a load center or panelboard for one or more power circuits including a glowing contact. The gas detection module includes a sensor to detect carbon dioxide, carbon monoxide and/or hydrogen chloride, which are evolved from the power circuit glowing contact. A microprocessor receives a concentration signal from the sensor, determines when such signal exceeds a predetermined threshold level of the detected gas, and responsively shuts down the entire load center by shunt tripping the main circuit breaker. The gas detection module may be located with or inside the load center.

There is room for improvement in electrical distribution apparatus.

### SUMMARY OF THE INVENTION

This need and others are met by the present invention, which provides a sensor structured to detect smoke or gas emitted from overheated plastic and to trip an electrical switching apparatus of an electrical distribution apparatus in response to the detected smoke or gas emitted from overheated plastic, or to annunciate the detected smoke or gas emitted from overheated plastic.

In accordance with one aspect of the invention, an electrical distribution apparatus comprises: an enclosure; a number of electrical switching apparatus within the enclosure; a smoke or gas sensor structured to detect smoke or gas emitted from overheated plastic within the enclosure; and a circuit cooperating with the smoke or gas sensor and being structured to trip one of the electrical switching apparatus in response to the detected smoke or gas emitted from overheated plastic or to annunciate the detected smoke or gas emitted from overheated plastic.

The smoke or gas sensor may be a sensor structured to detect gas emitted from overheated plastic. The gas sensor may be structured to detect hydrogen.

The gas sensor may include an output that varies as a function of the gas emitted from overheated plastic; and the circuit may comprise a comparator including a first input operatively associated with the output of the gas sensor and a second input having a predetermined threshold. The comparator may further include an output; and the circuit may further comprise an annunciator driven by the output of the comparator.

The annunciator may be an indicator or an alarm.

The comparator may further include an output; and one of the electrical switching apparatus may be a main circuit breaker of the electrical distribution apparatus, the main circuit breaker including a trip input driven by the output of the comparator.

The main circuit breaker may be a solenoid operated circuit breaker.

The gas sensor may include a resistance that varies as a function of the gas emitted from overheated plastic; the circuit may comprise a power supply, a resistor and a comparator including a first input and a second input having a predetermined threshold; and the resistance of the gas sensor may be electrically connected in series with the resistor at a node which is electrically connected to the first input of the comparator.

The smoke or gas sensor may be a smoke sensor. The smoke sensor may be a photo-electric sensor.

### BRIEF DESCRIPTION OF THE DRAWINGS

A full understanding of the invention can be gained from the following description of the preferred embodiments when read in conjunction with the accompanying drawings in which:

FIG. 1 is a block diagram of a load center in accordance with the present invention.

FIG. 2 is a block diagram of a smoke sensor and trip circuit for a load center in accordance with an embodiment of the invention.

FIG. 3 is a block diagram of a gas sensor and trip circuit for a load center in accordance with another embodiment of the invention.

### DESCRIPTION OF THE PREFERRED EMBODIMENTS

As employed herein, the term “number” shall mean one or an integer greater than one (i. e., a plurality).

As employed herein, the term “plastic” shall mean a plastic substance, specifically, any of numerous organic, synthetic or processed materials that are at least mostly thermoplastic or thermosetting polymers of suitably high molecular weight and that can or are made into objects, such as, for example, the plastic housing of a circuit interrupter.

As employed herein, the term “gas emitted from overheated plastic” shall mean one, or a mixture of at least some, of any of the following gases, compounds or isomers: hydrogen (e.g., H₂), propane (e.g., CH₃CH₂CH₃), ammonia (e.g., NH₃), butane (e.g., CH₃CH₂CH₂CH₃), acrylonitrile (e.g., CH₂═CHCN), nitrous oxide (e.g., N₂O), nitrogen dioxide or nitrous dioxide (e.g., NO₂), nitric oxide (e.g., NO), chlorine dioxide (e.g., ClO₂), acetylene (e.g., C₂H₂), ethylene (e.g., C₂H₄), ethane (e.g., C₂H₆), and methane (e.g., CH₄), and isomers of these compounds.

The present invention is described in association with a load center, although the invention is applicable to a wide range of electrical distribution apparatus (e.g., without limitation, panelboards; motor control centers; switchgear).

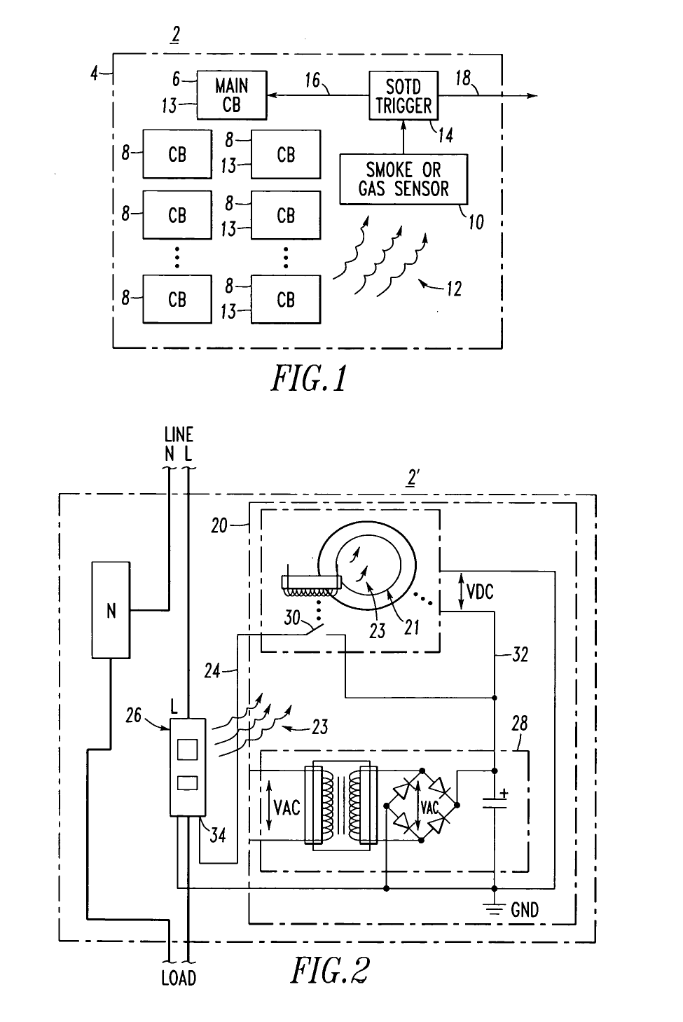

Referring to FIG. 1, an electrical distribution panel, such as for example, load center 2, includes an enclosure 4, and one or more electrical switching apparatus, such as for example, circuit breakers 6, 8, within the enclosure 4. A smoke or gas sensor 10 is structured to detect smoke or gas 12 which is emitted from overheated plastic 13 within the enclosure. A suitable circuit, such as, for example and without limitation, a solenoid operated trip device (SOTD) trigger circuit 14, that may be incorporated inside the main circuit breaker 6 or as part of a shunt trip solenoid, cooperates with the smoke or gas sensor 10. The SOTD trigger circuit 14 is structured to trip the main circuit breaker 6 in response to the detected smoke or gas 12 or to annunciate the detected smoke or gas. For example, the smoke or gas sensor 10 detects smoke or gas (e.g., without limitation, hydrogen gas) emitted from structures made of overheated plastic 13 inside the load center 2. Preferably, the smoke or gas sensor 10 is located at or near the top of the enclosure 4, in order to detect rising smoke or gas, such as 12.

As an alternative to, or in addition to, the trip signal 16 from the circuit 14 to the main circuit breaker 6, an annunciation signal 18 (e.g., indicator (e.g., audible; visual; audio-visual); alarm) may be output by the circuit 14 to alert a person or external apparatus (not shown) of the potentially unsafe condition arising from the detected smoke or gas 12 rather than, or in addition to, shutting off power through the main circuit breaker 6.

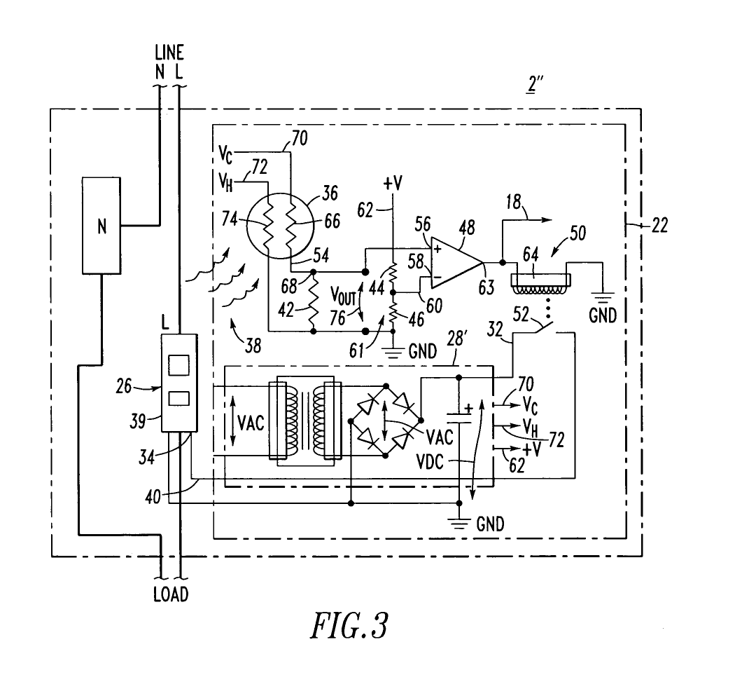

Sensing may be accomplished by a wide range of suitable sensing mechanisms. As non-limiting examples, a smoke sensor 20 (FIG. 2) or a specific gas sensor 22 (FIG. 3) may be employed to detect the respective smoke or gas emitted from overheated plastic.

Referring to FIG. 2, a load center 2′, which may be similar to the load center 2 of FIG. 1, includes the smoke sensor 20, which includes, for example, a photo-electric sensor 21. For example, when a predetermined concentration of the smoke 23 reaches the smoke sensor 20, it sends a trip signal 24 (e.g., without limitation, 24 VDC) to a main circuit breaker 26 (e.g., without limitation, a solenoid operated circuit breaker; a circuit breaker operated through a shunt trip device (not shown)), thereby tripping the circuit breaker and, thus, protecting the load center 2′ from overheating.

In this example, the smoke sensor 20 includes the photo-electric sensor 21, an AC/DC power supply 28 (e.g., without limitation, 120 VAC to +24 VDC), and a contact output 30. When a sufficient concentration of the smoke 23 reaches the photo-electric sensor 21, the contact output 30 closes, thus applying the DC voltage 32 to the shunt trip input 34 of the main circuit breaker 26.

Referring to FIG. 3, a load center 2″, which may be similar to the load center 2 of FIG. 1, includes the gas sensor 22. For example, a suitable gas sensor 36 (e.g., marketed by Synkera Technologies Inc. of Longmont, Colo. as model 711, or as hydrogen sensor model 703 or 701) may be employed to detect hydrogen gas 38 given off from overheated components, such as, for example, polymers (not shown) in the housing 39 of the main circuit breaker 26.

Although a hydrogen sensor 36 is disclosed, other types of specific gases emitted from overheated plastic may be sensed using appropriate sensors. For example and without limitation, propane (CH₃CH₂CH₃), ammonia (NH₃), butane (CH₃CH₂CH₂CH₃), acrylonitrile (CH₂═CHCN), nitrous oxide (N₂O), nitrogen dioxide or nitrous dioxide (N_{O}2), nitric oxide (NO), chlorine dioxide (ClO₂), acetylene (e.g., C₂H₂), ethylene (e.g., C₂H₄), ethane (e.g., C₂H₆), and methane (e.g., CH₄), and isomers of these compounds may be detected by gas sensors as shown in Table 1.

TABLE 1

| Gas | Sensor Type | Manufacturer | Location |
|---|---|---|---|
| propane | TGS 2610 | Figaro USA Inc. | Glenview, IL |
| propane | TGS 813 | Figaro USA Inc. | Glenview, IL |
| ammonia | TGS 826 | Figaro USA Inc. | Glenview, IL |
| butane | TGS 2610 | Figaro USA Inc. | Glenview, IL |
| butane | TGS 813 | Figaro USA Inc. | Glenview, IL |
| acetylene | TGS 813 | Figaro USA Inc. | Glenview, IL |
| acetylene | TGS 2610 | Figaro USA Inc. | Glenview, IL |
| ethylene | TGS 813 | Figaro USA Inc. | Glenview, IL |
| ethylene | TGS 2610 | Figaro USA Inc. | Glenview, IL |
| ethane | TGS 813 | Figaro USA Inc. | Glenview, IL |
| ethane | TGS 2610 | Figaro USA Inc. | Glenview, IL |
| methane | TGS 813 | Figaro USA Inc. | Glenview, IL |
| methane | TGS 2610 | Figaro USA Inc. | Glenview, IL |
| hydrogen | TGS 821 | Figaro USA Inc. | Glenview, IL |
| acrylonitrile | CEA 420-B | CEA Instruments, Inc. | Emerson, NJ |
| nitrous oxide | MGA 3000 | CEA Instruments, Inc. | Emerson, NJ |
| nitrous dioxide | CEA 420-B | CEA Instruments, Inc. | Emerson, NJ |
| nitric oxide | CEA 420-B | CEA Instruments, Inc. | Emerson, NJ |
| chlorine dioxide | CEA 420-B | CEA Instruments, Inc. | Emerson, NJ |
| acetylene | Flamgard Plus | CEA Instruments, Inc. | Emerson, NJ |
| ethylene | Flamgard Plus | CEA Instruments, Inc. | Emerson, NJ |
| ethane | Flamgard Plus | CEA Instruments, Inc. | Emerson, NJ |
| methane | Flamgard Plus | CEA Instruments, Inc. | Emerson, NJ |

For example, when a predetermined concentration of hydrogen gas 38 reaches the sensor 36, the sensor 22 sends a trip signal 40 (e.g., without limitation, 24 VDC) to main circuit breaker 26, thereby tripping the circuit breaker and, thus, protecting the load center 2″ from the potentially hazardous condition.

In this example, the sensor 22 includes the gas sensor 36, an AC/DC power supply 28′ (e.g., without limitation, 120 VAC to +24 VDC), resistors 42, 44, 46, comparator 48 and relay 50. When a sufficient concentration of the hydrogen gas 38 reaches the sensor 36, the relay contact 52 closes, thus applying the DC voltage 32 to the shunt trip input 34 of the main circuit breaker 26.

The sensor 36 includes an output 54 that varies as a function of the concentration of the hydrogen gas 38. The comparator 48 (e.g., without limitation, LM339) includes a first non-inverting input 56 operatively associated with the sensor output 54 and a second inverting input 58 having a predetermined threshold voltage 60 established by the resistors 44,46, which form a divider 61 for a power supply voltage 62 (+V). The comparator 48 also includes an output 63 that drives the coil 64 of the relay 50. When the sufficient concentration of the hydrogen gas 38 reaches the sensor 36, the comparator output 63 is high and energizes the relay coil 64, thereby closing the relay contact 52 and applying the power supply voltage 32 to the main circuit breaker trip input 34.

The sensor 36 includes a resistance 66 that varies as a function of the concentration of the hydrogen gas 38. The sensor resistance 66 is electrically connected in series with the resistor 42 (R_{L}) at a node 68 which is electrically connected to the first non-inverting comparator input 56. The power supply 28′ provides three output voltages 70, 72, 62 for the sensor 36 and comparator 48. The first circuit voltage 70 (V_{C}) may be, for example, between about 9 and about 24 VDC. The sensor output 54 may range from about 0 to about 5 VDC, which can be adjusted for sensor offset and gain. The second heater voltage 72 (V_{H}) powers a heater resistance 74 of the sensor 36. The third voltage 62 (+V) powers the divider 61. The heater voltage 72 (V_{H}) is applied to the resistance 74 in order to maintain a suitably constant, elevated temperature, for optimum sensing. The circuit voltage 70 (V_{C}) is applied to allow a measurement of the output voltage 76 (Vout) across the load resistor 42 (R_{L}). The sensor resistance 66 (R_{S}), which varies with respect to the concentration of the hydrogen gas 38, is determined from Equation 1.
R_{S}=(V_{C}−Vout)×(R_{L}/Vout) (Eq. 1)

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. An electrical distribution apparatus comprising:
an enclosure;
a number of electrical switching apparatus within said enclosure;
a smoke or gas sensor structured to detect smoke or gas emitted from overheated plastic within said enclosure; and
a circuit cooperating with said smoke or gas sensor and being structured to trip one of said electrical switching apparatus in response to said detected smoke or gas emitted from overheated plastic or to annunciate said detected smoke or gas emitted from overheated plastic.

2. The electrical distribution apparatus of claim 1 wherein said electrical distribution apparatus is a panelboard.

3. The electrical distribution apparatus of claim 1 wherein said electrical distribution apparatus is a load center.

4. The electrical distribution apparatus of claim 1 wherein said smoke or gas sensor is a gas sensor structured to detect gas emitted from overheated plastic.

5. The electrical distribution apparatus of claim 4 wherein said gas sensor structured to detect gas emitted from overheated plastic is structured to detect hydrogen.

6. The electrical distribution apparatus of claim 4 wherein said gas sensor structured to detect gas emitted from overheated plastic is structured to detect at least one of hydrogen, propane, ammonia, butane, acrylonitrile, nitrous oxide, nitrous dioxide, nitric oxide, chlorine dioxide, acetylene, ethylene, ethane and methane.

7. The electrical distribution apparatus of claim 4 wherein said gas sensor structured to detect gas emitted from overheated plastic includes an output that varies as a function of said gas emitted from overheated plastic; and wherein said circuit comprises a comparator including a first input operatively associated with the output of said gas sensor structured to detect gas emitted from overheated plastic and a second input having a predetermined threshold.

8. The electrical distribution apparatus of claim 7 wherein said comparator further includes an output; and wherein said circuit further comprises an annunciator driven by the output of said comparator.

9. The electrical distribution apparatus of claim 7 wherein said annunciator is an indicator or an alarm.

10. The electrical distribution apparatus of claim 7 wherein said comparator further includes an output; and wherein at least one of said electrical switching apparatus includes a trip input driven by the output of said comparator.

11. The electrical distribution apparatus of claim 7 wherein said comparator further includes an output; and wherein one of said electrical switching apparatus is a main circuit breaker of said electrical distribution apparatus, said main circuit breaker including a trip input driven by the output of said comparator.

12. The electrical distribution apparatus of claim 11 wherein said main circuit breaker is a solenoid operated circuit breaker.

13. The electrical distribution apparatus of claim 7 wherein said comparator further includes an output; and wherein one of said electrical switching apparatus is a circuit breaker of said electrical distribution apparatus, said circuit breaker including a shunt trip input controlled by the output of said comparator.

14. The electrical distribution apparatus of claim 4 wherein said gas sensor structured to detect gas emitted from overheated plastic includes a resistance that varies as a function of said gas emitted from overheated plastic; wherein said circuit comprises a power supply, a resistor and a comparator including a first input and a second input having a predetermined threshold; and wherein the resistance of said gas sensor structured to detect gas emitted from overheated plastic is electrically connected in series with said resistor at a node which is electrically connected to the first input of said comparator.

15. The electrical distribution apparatus of claim 1 wherein said smoke or gas sensor is a smoke sensor.

16. The electrical distribution apparatus of claim 15 wherein said smoke sensor is a photo-electric sensor.

17. The electrical distribution apparatus of claim 1 wherein said smoke or gas sensor includes an output; and wherein said circuit further comprises an annunciator driven by the output of said smoke or gas sensor.

18. The electrical distribution apparatus of claim 17 wherein said annunciator is an indicator.

19. The electrical distribution apparatus of claim 17 wherein said annunciator is an alarm.

20. The electrical distribution apparatus of claim 1 wherein said smoke or gas sensor includes an output; and wherein at least one of said electrical switching apparatus includes a trip input driven by the output of said smoke or gas sensor.

21. The electrical distribution apparatus of claim 20 wherein said at least one of said electrical switching apparatus is a main circuit breaker of said electrical distribution apparatus, said main circuit breaker including said trip input.
